(19) United States
(12) Patent Application Publication
(10) Pub. No.: US 2024/0403254 A1
(43) Pub. Date: Dec. 5, 2024

(54) Serving Large Language Models with 3D-DRAM Chiplets

(71) Applicant: Google LLC, Mountain View, CA (US)

(72) Inventors: Xiaoyu Ma, Newark, CA (US); David Patterson, Albany, CA (US)

(21) Appl. No.: 18/210,846

(22) Filed: Jun. 16, 2023

Related U.S. Application Data
(60) Provisional application No. 63/505,725, filed on Jun. 2, 2023.

(51) Int. Cl. G06F 13/42; G06F 13/40; G06F 15/173

(52) U.S. Cl. CPC G06F 13/4221; G06F 13/4068; G06F 15/17331

(57) ABSTRACT

Disclosed systems and methods herein provide for high bandwidth processing using a plurality of compute-memory chiplets. A computing package may be configured with a plurality of the compute-memory chiplets in order to perform processing operations in connection with a large language model. The compute-memory chiplets may be configured to operate using small, low-power computing dies that can efficiently operate for workloads with low arithmetic intensity.

### CROSS-REFERENCE TO RELATED APPLICATIONS

The present application claims the benefit of the filing date of U.S. Provisional Patent Application No. 63/505,725, filed Jun. 2, 2023, the disclosure of which is hereby incorporated herein by reference.

### BACKGROUND

High performance computing can be performed using computing packages that have a plurality of high bandwidth memory (“HBM”) dies. However, these packages have been configured to operate for applications that involve high arithmetic intensity through the use of a high-power computing die. However, the high arithmetic intensity and high-power design of current packages make them suboptimal for serving as machine learning accelerators of large language models.

### BRIEF SUMMARY

What is needed is a high-bandwidth memory package design that is configured to efficiently operate as a machine learning accelerator for applications with low arithmetic intensity, such as for serving Large Language Models (LLMs) or other models limited by memory bandwidth. Aspects of the disclosure are directed to a machine learning accelerator with 3D-memory dies implemented with a plurality of chiplets for increased bandwidth. The machine learning accelerator is further designed for low arithmetic intensity to reduce the power needed to operate of the package. In addition, aspects of the disclosure allow for the machine learning accelerator to operate on a package that is limited with regard to thermal constraints and with regard to the amount of space that is available for computing and memory components.

In accordance with aspects of the disclosure, a computing package may comprises a package substrate; and one or more computing clusters located on the package substrate; wherein each of the one or more computing clusters includes a plurality of compute-memory stacks in communication with an input-output die; wherein each compute-memory stack may include a plurality of memory dies stacked with a low-power compute die; and wherein the input-output die may be configured to transmit data for the plurality of compute-memory stacks via one or more peripheral component interconnects.

In other aspects of the disclosure, each low-power compute die of the plurality of compute-memory stacks may be configured to operate on a power supply of about 40 W or less.

In still other aspects, for a particular compute-memory stack from the plurality of compute-memory stacks, the low-power compute die has a footprint on the package substrate that is less than 30% larger than a footprint of the plurality of memory dies.

In yet other aspects of the disclosure, the computing package may further comprise a plurality of computing clusters located on the package substrate, and wherein the input-output die for each computing cluster is connected to one or more input-output dies of the other computing clusters located on the package substrate.

In still other aspects of the disclosure, the package substrate may include four computing clusters, and wherein each computing cluster contains four or more compute-memory stacks. In addition, each computing cluster may contain at least one inactive spare compute-memory stack.

In other aspects of the disclosure, the package substrate may include two computing clusters, and wherein each computing cluster contains eight or more compute-memory stacks. In addition, each computing cluster may contain at least one inactive spare compute-memory stack.

In yet other aspects of the disclosure, the plurality of compute-memory stacks are stacked 3D-DRAM chiplets, and the computing package is configured to operate as a large model processing unit.

In still other aspects of the disclosure, the input-output die may be further configured to communicate with at least one of an external DRAM or external Remote Direct Memory Access (RDMA) for interconnecting with other computing packages.

In other aspects of the disclosure, a method of computing may comprise: receiving processing commands at one or more computing clusters located on a package substrate; performing computing operations based on the processing commands using a plurality of compute-memory stacks in communication with an input-output die, wherein each compute-memory stack includes a plurality of memory dies stacked with a low-power compute die; and transmitting data from the input-output die via one or more peripheral component interconnects.

In still another aspect of the disclosure, each low-power compute die of the plurality of compute-memory stacks may be configured to operate on a power supply of about 40 W or less.

In yet other aspects of the disclosure, a particular compute-memory stack from the plurality of compute-memory stacks, the low-power compute die may have a footprint on the package substrate that is less than 30% larger than a footprint of the plurality of memory dies.

In still other aspects of the disclosure, performing the computing operations may further comprise performing the computing operations using a plurality of computing clusters located on the package substrate, and wherein the input-output die for each computing cluster is connected to one or more input-output dies of the other computing clusters located on the package substrate.

In other aspects of the disclosure, the input-output die may be further configured to communicate with at least one of an external DRAM or external Remote Direct Memory Access (RDMA) for interconnecting with other computing packages.

In still other aspects of the disclosure, a large model processing unit may comprise one or more computing packages connected via peripheral component interconnects, and each computing package may comprise: a package substrate; and one or more computing clusters located on the package substrate; wherein each of the one or more computing clusters includes a plurality of compute-memory stacks in communication with an input-output die; wherein each compute-memory stack includes a plurality of memory dies stacked with a low-power compute die; and wherein the input-output die is configured to transmit data for the plurality of compute-memory stacks via the one or more peripheral component interconnects.

### BRIEF DESCRIPTION OF THE DRAWINGS

FIG. 1 is a block diagram of a computing package having compute-memory chiplets in accordance with aspects of the disclosure.

FIG. 2 is a block diagram of a partial side view of a computing package having compute-memory chiplets in accordance with aspects of the disclosure.

FIG. 3 is a block diagram of a computing package that does not contain compute-memory chiplets.

FIG. 4 is a block diagram of a computing package having two clusters of compute-memory chiplets in accordance with aspects of the disclosure.

FIG. 5 is a block diagram of a computing package having clusters of memory stacks in communication with compute and IO dies in accordance with aspects of the disclosure.

FIG. 6 is a flow diagram of an example process for performing computing operations in accordance with aspects of the disclosure.

### DETAILED DESCRIPTION

The technology generally relates to high bandwidth processing in low arithmetic intensity environments. For example, systems and methods are disclosed for use in large model processing, which can include the use of machine learning accelerators for serving large language models (LLMs). The machine learning accelerator can include a plurality of chiplets, each with a 3D-memory die. The machine learning accelerator can be designed to exploit the low arithmetic intensity associated with LLM processing by including a plurality of low-power and small compute dies in each of the plurality of chiplets.

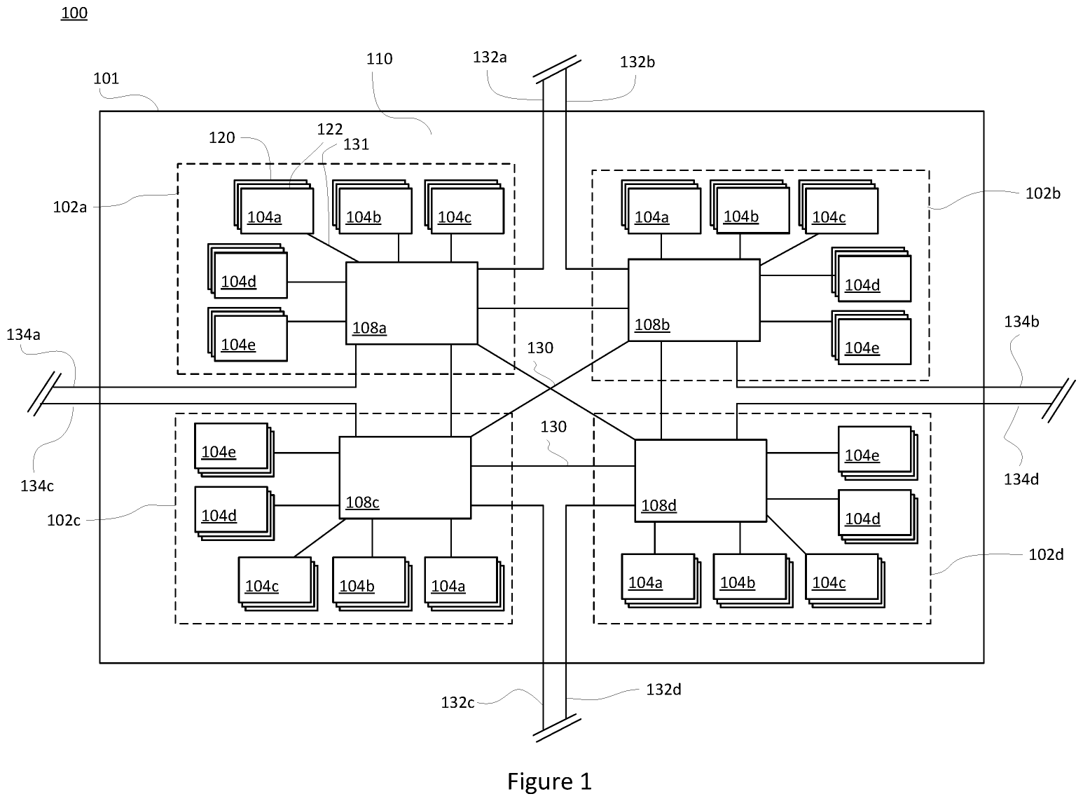

FIG. 1 is a block diagram 100 of a multi-chip package 101 that can operate as a machine learning accelerator in accordance with aspects of the disclosure. The multi-chip package 101 can include a substrate 110 on which a plurality of computing clusters 102a-d are located. Each of the clusters 102a-d can include an input/output (IO) die 108 and a plurality of compute-memory chiplets 104a-e. Each chiplet 104 can include a compute die 120 and a 3D-stack of a plurality of memory dies 122. For example, as shown in block diagram 100, chiplet 104a of cluster 102a has a compute die 120 that is stacked with a plurality of memory dies 122. The other chiplets 104b-e of cluster 102a, as well as the chiplets 104a-e of the other clusters 102b-d, can contain a similar set of memory dies 122 that are stacked onto a compute die 120.

Each chiplet 104a-e within a cluster 102 is connected to a corresponding IO die 108 within the cluster 102. For example, as shown in block diagram 100, chiplet 104a is connected to IO die 108a via connection 131. A similar connection exists between IO die 108a and each of the other chiplets 104b-e of cluster 102a. In addition, the clusters 102a-d of multi-chip package 101 can be connected to each other via the IO dies 108a-d. For example, each IO die 108a-d may be connected to every other IO die 108a-d via connections 130. For simplicity, only some of the connections 130 of block diagram 100 have been identified with a reference number. Each chiplet 104a-e within a cluster 102 may also be configured to communicate with one another directly via additional connections (not shown).

The IO dies 108a-d of each cluster 102a-d may also be configured to transmit with components or devices that are external to the multi-chip package 101. For example, connections 132a-d can be configured so that IO dies 108a-d can communicate with external dynamic random access memory (DRAM) or external inter-core interconnects (ICIs). In addition, IO dies 108a-d may each be configured to transmit data via peripheral component interconnect express (PCIe) connections 134a-d. Each PCIe connection 134a-d shown in FIG. 1 may be configured to transmit data for all of the chiplets 104a-e within a given cluster. Thus, multi-chip package 101 may be configured to communicate with other multi-chip packages and be configured to operate as a machine learning accelerator that is part of a large language model server.

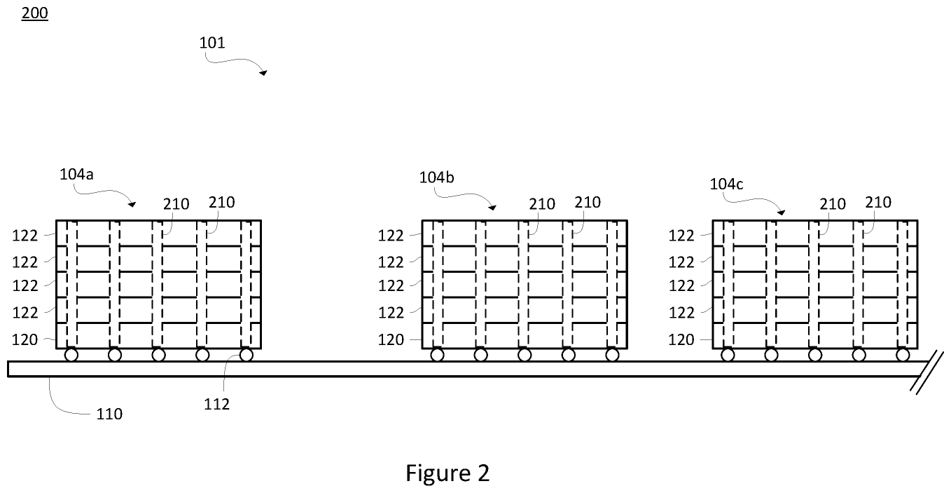

FIG. 2 is a block diagram 200 of a partial side view of multi-chip package 101 in which the compute dies 120 and memory dies 122 for chiplets 104a-c are shown. Each chiplet 104a-c contains a plurality of memory dies 122 that are stacked onto a compute die 120. Each compute die 120 may be connected directly to a substrate 110, such as a circuit board, via electrical connections 112. The plurality of memory dies 122, may be a 3D stack of HBM dies that have been stacked onto compute die 120, and each memory die 122 may be electrically connected to adjacent memory dies 122 within the stack so as to allow for HBM electrical signals to be passed through the chiplet 104. As shown in block diagram 200, compute die 120 and memory dies 122 may be configured to contain one or more internal through-silicon vias (TSVs 210) that extend through the stack of dies within chiplet 104. Electrical connections between compute die 120 and the plurality of memory dies may exist via the TSVs 210. While each chiplet 104a-c is shown as containing four memory dies 122, the number of memory dies 122 on a given chiplet may vary based on the capacity required for a given application, as well as based on the total number of chiplets 104 that are included on the package 101. In particular, fewer memory dies 122 may be required per chiplet when a larger number of chiplets are used per package 101. Thus, an increase in the number of chiplets 104 can reduce the height of package 101, and can reduce the thermal constraints and cooling requirements that would be present if a larger stack of memory dies 122 were used.

With each chiplet 104 containing its own compute die 120, the chiplets 104 may be designed with smaller compute dies than would be required if only a single compute die was used for all of the memory dies 122 within the cluster or within the package 101. In accordance with aspects of the disclosure, the compute die 120 of each chiplet 104 may be designed to have the same or similar footprint as the memory dies 122. For example, in diagram 200, the compute dies 120 are shown as having the same footprint as the memory dies 122 with which they are stacked. Alternatively, the compute dies 120 may have a footprint on the package substrate that is less than 30% larger than the footprint of the memory dies 122 with which they are stacked. Thus, package 101 may be able to accommodate a large number of small, low-power chiplets 104. In addition, the stacked configuration of the compute die 120 and memory dies 122 allows chiplets 104 of package 101 to be directly connected to substrate 110 without requiring the use of an interposer.

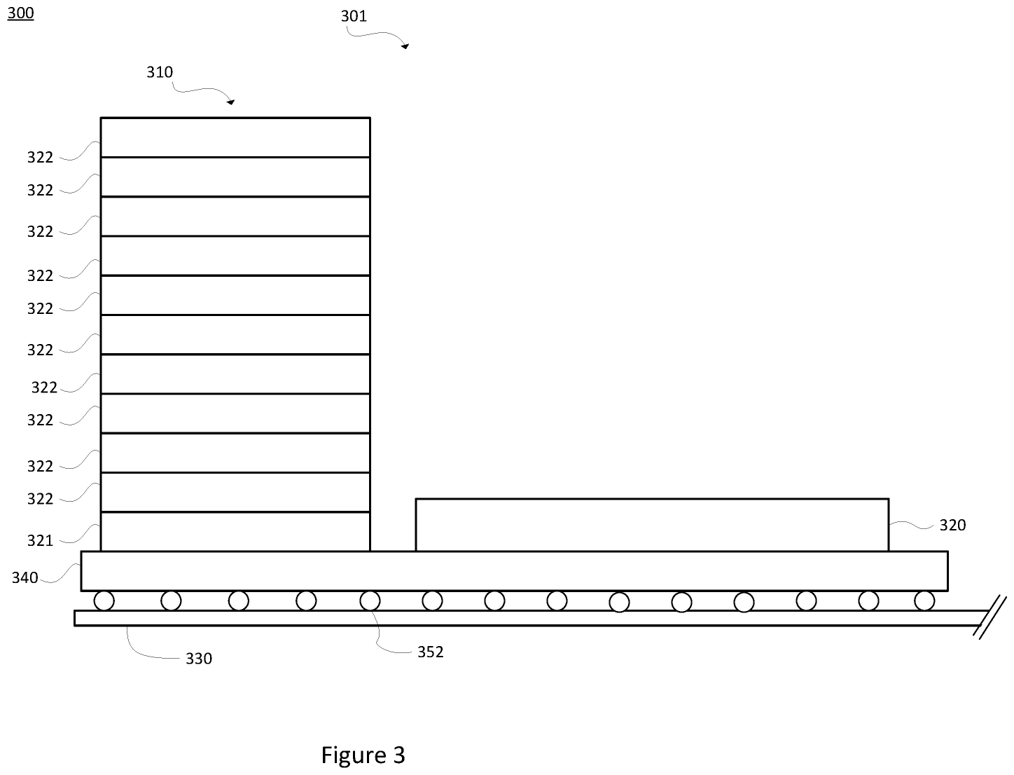

For example, FIG. 3 is a block diagram 300 of a package 301 that does not use the compute-memory chiplets 104 described in connection with FIGS. 1 and 2. In particular, compute die 320 and memory stack 310 are each connected to an interposer 340, which is itself connected via electrical connections 352 to substrate 330. Compute die 320 communicates with the plurality of memory dies 322 within memory stack 310 via interposer 340. Thus, the number, size, and placement of the compute die 320 and memory dies 322 are limited by the interposer 340 that is used. Moreover, package 301 is configured such that the single compute die 320 performs all of the processing for the entire package 301, and the single compute die 320 is required to access all ten of the memory dies 322 within memory stack 310. In this configuration, compute die 320 has a footprint that is more than twice the size of the memory dies 322.

Returning to FIG. 1, package 101 may have dimensions that allow it to fit within other packages on preexisting substrates. The specific numbers described herein are exemplary only and not intended to be limiting, however by way of example only, package 101 may have a length and width relative to a substrate of around 60 mm by 60 mm, the compute dies 120 may each have a footprint of around 100 mm², and the IO dies 108 may each have a footprint of around 150 mm². The memory dies 122 may be 3D-stacked dynamic random access memory (DRAM) dies with a bandwidth of around 800 GB/s, a capacity of around 4 GB, and a thermal design power (TDP) of around 10 W per die. The compute dies 120 may each have a thermal design power of around 40 W or less, with around 32 TFLOPS of processing, and around 32 MB SRAM. The IO dies 108a-d may have a thermal design power of around 35 W TDP.

The package 101 can enable high bandwidth communication between IO dies 108. As an example, the total IO bandwidth per IO die 108 may be up to several TB/s, e.g., up to 4 TB/s. For example, 400 GB/s of bandwidth may be dedicated to each compute die 120 within the cluster 102 and 400 GB/s of bandwidth may be dedicated to each IO die 108 within the package 101. As another example, if high bandwidth IO die communication is not needed, the total IO bandwidth per IO die 108 may be lower, e.g., around 400 GB/s. For instance, for each IO die 108, 160 GB/s of bandwidth may be dedicated to the compute dies 120 within the cluster 102, 150 GB/s of bandwidth may be dedicated to other IO dies 108 within the package 101, 16 GB/s of bandwidth may be dedicated to a host, such as to a host device supporting PCIe Gen5, 64 GB/s of bandwidth may be dedicated to external DRAM, and 50 GB/s bandwidth may be dedicated for external RDMA. The IO dies 108 can contain lightweight compute for smart routing, such as aggregation of partial sums computed by memory-compute stacks connected to the IO dies 108, and can be connected to external components for extra processing.

In accordance with aspects of the disclosure, each cluster 102 of package 101 may be configured so that at least one chiplet 104 within the cluster 102 is at least initially designated as a cold spare. For example, of the five chiplets 104a-e in cluster 102a, four chiplets 104a-d may be designated as active, while a fifth chiplet 104e is designated as an inactive spare. Accordingly, IO die 108 will only communicate with chiplets 104a-d for the processing operations of the machine learning accelerator. However, IO die may also be configured to receive and transmit diagnostic information regarding the operation of each of the active chiplets 104a-d and replace any faulty chiplet 104a-d with the spare chiplet 104e. For example, if active chiplet 104a is determined to have experienced a fault, or is otherwise not operating correctly, chiplet 104a can be re-designated from being an active chiplet to being an inactive chiplet, and spare chiplet 104e can be re-designated from being a an inactive spare chiplet to being an active chiplet. Package 101 may thus be designed for increased reliability, in that a fault in any one chiplet 104 will not impair the operation of the machine learning accelerator as a whole. In this configuration, package 101 will have four spare chiplets and 16 active chiplets.

In an example in which each of the 16 active compute dies 120 has a TDP of 40 W, each of the 16 DRAM dies has a TDP of 10 W, and each of the four IP dies has a TDP of 35 W, then the total TDP for the package 101 as a whole will be 620 W. However, even with the use of low-power compute dies 120, including compute dies 120 with TDP of around 10-40 W, the use of a plurality of compute-memory chiplets allows package 101 to perform large language model processing with an increased overall bandwidth relative to conventional HBM configurations. This increased bandwidth is a function of the number of chiplets 104 that are used within a package, and the small size and low power consumption of the compute dies 120 allows for a greater number of chiplets 104 to be used per package, while the low arithmetic intensity of large language model processing will not prevent the small, low-power compute dies 120 from operating efficiently.

For large language models, the arithmetic intensity of the processing can be an order of magnitude less than other machine learning processing, and the current architecture for machine learning accelerators can be over-provisioned for this level of low arithmetic intensity by 10-times or more. However, in connection with package 101, the size (100 mm²) and thermal design power (10-40 W) of compute dies 120 allows for a larger number of compute-memory chiplets 104 to be used. This large number of compute-memory chiplets 104 increases the available bandwidth for low arithmetic intensity applications, without increasing the cost of operation relative to conventional machine learning accelerators.

In accordance with aspects of the disclosure, package 101 can be configured to operate in a manner in which multiple levels of sharding are performed in distributing the processing to the various chiplets 104. For example, if an large language model is sharded to 16 GB in connection with a conventional machine learning accelerator, the currently disclosed system can be configured to perform the same sharding algorithm, where each compute-memory stack is a shard, with the difference being that the memory capacity per shard (4 GB) is smaller than the shard size (16 GB) used by the conventional machine learning accelerator mentioned above.

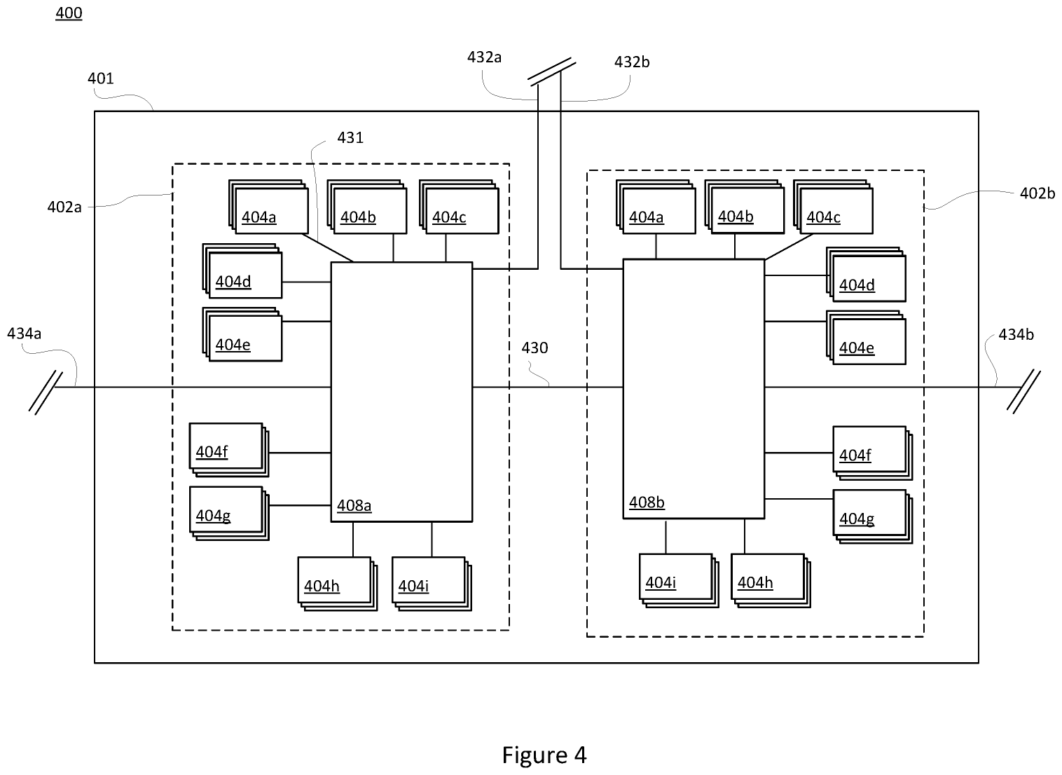

In accordance with the aspects of the disclosure, a machine learning accelerator may utilize one or more packages having different dimensions and having compute-memory chiplets and other components with different specifications than those described above. For example, FIG. 4 is a block diagram 400 of another example package 401, which may be implemented as part of a machine learning accelerator for a large language model. Package 401 may be configured to operate in a manner similar to package 101 described above. However, as shown in FIG. 4, Package 401 contains two computing clusters 402a-b. Each cluster 402 contains an IO die 408 and nine chiplets 404a-i.

Each chiplet 404a-e within a cluster 402a-b may be connected to a corresponding IO die 408a-b within the cluster 402a-b, respectively. For example, as shown in block diagram 400, chiplet 404a is connected to IO die 408a via connection 431. A similar connection exists between IO die 408a and each of the other chiplets 404b-i of cluster 402a. In addition, the cluster 402a-b of multi-chip package 401 can be connected to each other via the IO dies 408a and 408b. For example, IO die 408a and 408b may be connected via connection 430. Each chiplet 404a-i within a cluster 402 may also be configured to communicate with one another directly via additional connections (not shown).

The IO dies 408a and 408b of each cluster 402a and 402b may also be configured to transmit with components or devices that are external to the multi-chip package 401. For example, connections 432a-b can be configured so that IO dies 408a-b can communicate with external dynamic random access memory (DRAM) or external inter-core interconnects (ICIs). In addition, IO dies 408a-b may each be configured to transmit data via peripheral component interconnect express (PCIe) connections 434a-b. Each PCIe connection 434a-b shown in FIG. 4 may be configured to transmit data for all of the chiplets 104a-i within a given cluster. Thus, multi-chip package 401 may be configured to communicate with other multi-chip packages and be configured to operate as a machine learning accelerator that is part of a large language model server.

The architecture of package 401 can be such that it contains a different number of spares than the example described above for package 101, which provided for four spare chiplets 104 (one per cluster) and 16 active chiplets 104 (four per cluster). For example, package 401 can include one spare for each cluster 402a and 402b. Thus, at any given moment, package 401 may operate with 16 active chiplets 404 and 4 inactive spare chiplets 404.

The specific numbers described herein are exemplary only and not intended to be limiting, however by way of example only, package 401 can include 3D-stacked dynamic random access memory (DRAM) dies with around 800 GB/s of bandwidth, a capacity of 4 GB, and 10 W TDP per DRAM stack. The package 401 may further include compute dies with a footprint of 100 mm², a TDP of 20 W, processing of 32 TFLOPS, and 32 MB SRAM per die. The IO dies 408a-b may have a footprint of around 150 mm² and a TDP of 50 W per die. The total IO bandwidth per IO die 408 may be around 450 GB/s, e.g., 144 GB/s to compute dies, 128 GB/s to other IO dies, 32 GB/s to a host like a PCIe Gen5, 64 GB/s to external DRAM, and/or 50 GB/s for external RDMA. Package 401 can have an overall TDP of around 580 W with compute dies using a total of around 320 W, memory dies using around 160 W, and IO dies using around 100 W.

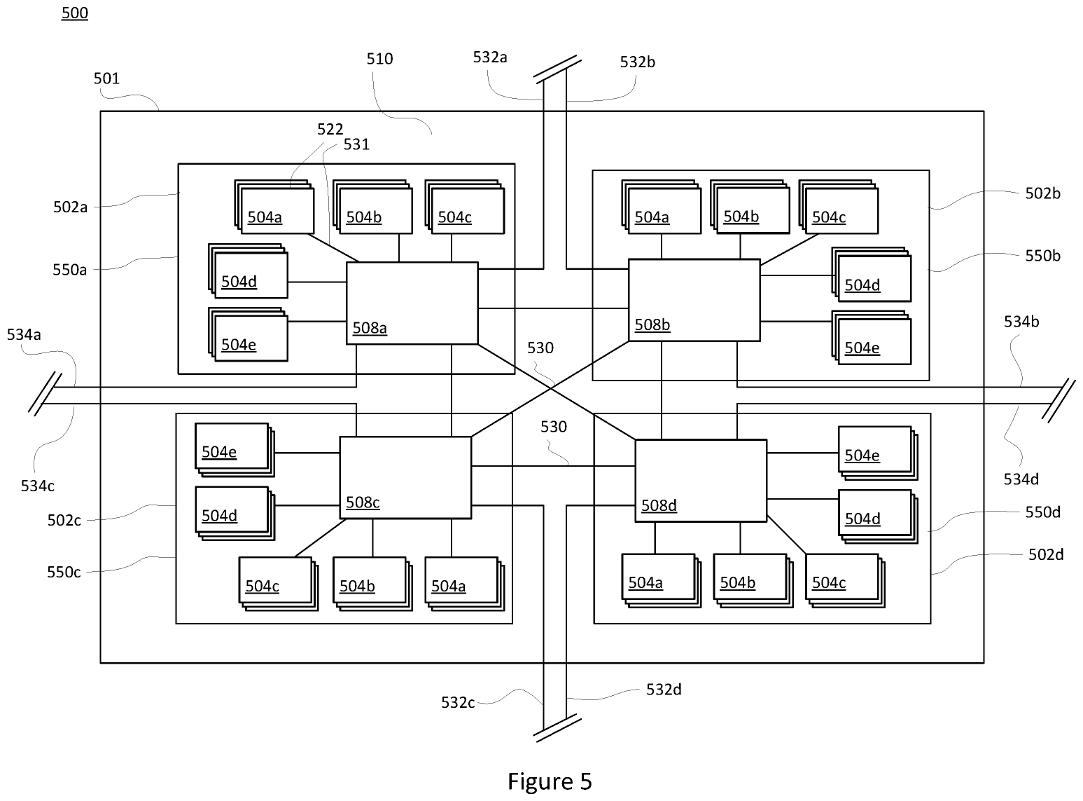

FIG. 5 is a block diagram 500 of another package 501 that can operate as a machine learning accelerator. For package 501, the clusters 502a-d contain memory stacks 504a-e that contain a plurality of memory dies 522, but do not contain a computing die. Instead, the computing and input-output operations are performed by compute and IO dies 508a-d. In addition to substrate 510, package 501 contains an interposer 550a-d for each of the clusters 502a-d. Thus, each of the clusters 502a-d can include an interposer 550a-d that is connected to substrate 510. Compute and IO die 508 and a plurality of memory stacks 504a-e are then connected to one of the interposers 550a-d.

Each memory stack 504a-e within a cluster 502 is connected to a corresponding compute and IO die 508 within the cluster 502. For example, as shown in block diagram 500, memory stack 504a is connected to IO die 508a via connection 531. A similar connection exists between compute and IO die 508a and each of the other memory stacks 504b-e of cluster 502a. In addition, the clusters 502a-d of package 501 can be connected to each other via the compute and IO dies 508a-d. For example, each compute and IO die 508a-d may be connected to every other compute and IO die 508a-d via connections 530. For simplicity, only some of the connections 530 of block diagram 500 have been identified with a reference number.

The compute IO dies 508a-d of each cluster 502a-d may also be configured to transmit with components or devices that are external to the package 501. For example, connections 532a-d can be configured so that compute and IO dies 508a-d can communicate with external dynamic random access memory (DRAM) or external inter-core interconnects (ICIs). In addition, compute and IO dies 508a-d may each be configured to transmit data via peripheral component interconnect express (PCIe) connections 534a-d. Each PCIe connection 134a-d shown in FIG. 5 may be configured to transmit data for all of the memory stacks 504a-e within a given cluster 502. Thus, multi-chip package 501 may be configured to communicate with other multi-chip packages and be configured to operate as a machine learning accelerator that is part of a large language model server.

The specific numbers described herein are exemplary only and not intended to be limiting, however by way of example only, package 501 may have a length and width relative to a substrate of around 80 mm by 80 mm, the compute and IO dies 508a-d may each have a footprint of around 200-300 mm², and the interposers 550a-d may each have a footprint of around 1000 mm². The memory dies 122 may be 3D-stacked dynamic random access memory (DRAM) dies with a bandwidth of around 800 GB/s, a capacity of around 16 GB, and a TDP of around 35 W per stack. The compute dies and IO dies 508a-d may each have a TDP of around 150 W, with around 128 TFLOPs of processing, and around 128 MB SRAM. The IO dies 108a-d may have a thermal design power of around 35 W TDP. In addition, each cluster may have four active memory stacks and one inactive spare stack. The total TDP for the 16 active memory stacks 104 may be around 560 W, and the total TDP for the four compute and IO dies may be around 600 W, while the interposer and package may require an additional 100 W. Accordingly, in this example, package 501 may have a total TDP of 1300 W.

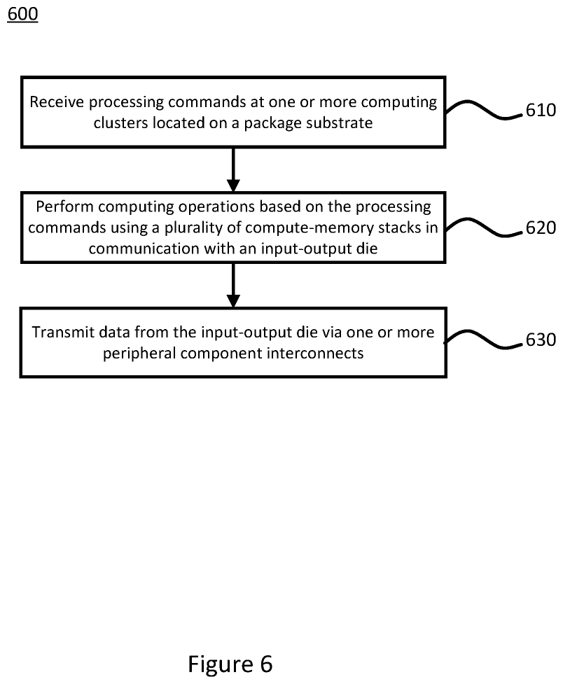

FIG. 6 is a flow diagram of an example process 600 for performing computing operations. The example process 600 can be performed on a system of one or more processors in one or more locations, such as the multi-chip package 101 as depicted in FIG. 1.

As shown in block 610, the multi-chip package 101 receives processing commands at one or more computing clusters located on a package substrate. Processing commands can include any instructions for processing data to perform any of a variety of computing operations. For example, these computing operations can include loading data into a computing circuit, moving data into one or more processing elements of the computing circuit, processing the data by one or more processing elements, and pushing the data out of the computing circuit.

As shown in block 620, the multi-chip package 101 performs computing operations based on the processing commands using a plurality of compute-memory stacks in communication with an input-output die. Each compute-memory stack includes a plurality of memory dies stacked with a low-power compute die. Each low-power compute die can be configured to operate on a power supply of about 40 W or less. For a particular compute-memory stack, the low-power compute die can have a footprint on the package substrate that is less than 30% larger than a footprint of the plurality of memory dies.

Performing the computing operations can further include performing the computing operations using a plurality of computing clusters located on the package substrate. The input-output die for each computing cluster can be connected to one or more input-output dies of other computing clusters located on the package substrate. For example, the package substrate can include four computing clusters where each computing cluster contains four or more active compute-memory stacks. As another example, the package substrate can include two computing clusters where each computing cluster contains eight or more active compute-memory stacks. Each computing cluster can contain at least one inactive spare compute-memory stack. The plurality of compute-memory stacks can be stacked 3D-DRAM chiplets.

As shown in block 630, the multi-chip package 101 transmits data from the input-output die via one or more peripheral component interconnects. The input-output die can be further configured to communicate with at least one of an external DRAM or external RDMA for interconnecting with other computing packages.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A computing package comprising:
a package substrate; and
one or more computing clusters located on the package substrate;
wherein each of the one or more computing clusters includes a plurality of compute-memory stacks in communication with an input-output die;
wherein each compute-memory stack includes a plurality of memory dies stacked with a low-power compute die; and
wherein the input-output die is configured to transmit data for the plurality of compute-memory stacks via one or more peripheral component interconnects.

2. The computing package of claim 1, wherein each low-power compute die of the plurality of compute-memory stacks is configured to operate on a power supply of about 40 W or less.

3. The computing package of claim 1, wherein for a particular compute-memory stack from the plurality of compute-memory stacks, the low-power compute die has a footprint on the package substrate that is less than 30% larger than a footprint of the plurality of memory dies.

4. The computing package of claim 1, further comprising a plurality of computing clusters located on the package substrate, and wherein the input-output die for each computing cluster is connected to one or more input-output dies of the other computing clusters located on the package substrate.

5. The computing package of claim 4, wherein the package substrate includes four computing clusters, and wherein each computing cluster contains four or more compute-memory stacks.

6. The computing package of claim 4, wherein the package substrate includes two computing clusters, and wherein each computing cluster contains eight or more compute-memory stacks.

7. The computing package of claim 1, wherein each computing cluster contains at least one inactive spare compute-memory stack.

8. The computing package of claim 1, wherein the plurality of compute-memory stacks are stacked 3D-DRAM chiplets.

9. The computing package of claim 1, wherein the computing package is configured to operate as a large model processing unit.

10. The computing package of claim 1, wherein the input-output die is further configured to communicate with at least one of an external DRAM or external Remote Direct Memory Access (RDMA) for interconnecting with other computing packages.

11. A method of computing comprising:
receiving processing commands at one or more computing clusters located on a package substrate;
performing computing operations based on the processing commands using a plurality of compute-memory stacks in communication with an input-output die, wherein each compute-memory stack includes a plurality of memory dies stacked with a low-power compute die; and
transmitting data from the input-output die via one or more peripheral component interconnects.

12. The method of claim 11, wherein each low-power compute die of the plurality of compute-memory stacks is configured to operate on a power supply of about 40 W or less.

13. The method of claim 11, wherein for a particular compute-memory stack from the plurality of compute-memory stacks, the low-power compute die has a footprint on the package substrate that is less than 30% larger than a footprint of the plurality of memory dies

14. The method of claim 11, wherein performing the computing operations further comprises performing the computing operations using a plurality of computing clusters located on the package substrate, and wherein the input-output die for each computing cluster is connected to one or more input-output dies of the other computing clusters located on the package substrate.

15. The method of claim 14, wherein the package substrate includes four computing clusters, and wherein each computing cluster contains four or more active compute-memory stacks.

16. The method of claim 14, wherein the package substrate includes two computing clusters, and wherein each computing cluster contains eight or more active compute-memory stacks.

17. The method of claim 11, wherein each computing cluster contains at least one inactive spare compute-memory stack.

18. The method of claim 11, wherein the plurality of compute-memory stacks are stacked 3D-DRAM chiplets.

19. The method of claim 11, wherein the input-output die is further configured to communicate with at least one of an external DRAM or external Remote Direct Memory Access (RDMA) for interconnecting with other computing packages.

20. A large model processing unit comprising one or more computing packages connected via peripheral component interconnects, each computing package comprising:
a package substrate; and
one or more computing clusters located on the package substrate;
wherein each of the one or more computing clusters includes a plurality of compute-memory stacks in communication with an input-output die;
wherein each compute-memory stack includes a plurality of memory dies stacked with a low-power compute die; and
wherein the input-output die is configured to transmit data for the plurality of compute-memory stacks via the one or more peripheral component interconnects.
